(19) United States
(12) Patent Application Publication
(10) Pub. No.: US 2026/0210112 A1
(43) Pub. Date: Jul. 23, 2026

(54) WALL PANEL SYSTEM

(71) Applicant: THREE SMITH GROUP LIMITED, Elland Yorkshire (GB)

(72) Inventors: Philip Coates, Elland Yorkshire (GB); Graham Martin, Elland Yorkshire (GB)

(21) Appl. No.: 19/142,024

(22) PCT Filed: Dec. 19, 2023
(86) PCT No.: PCT/GB2023/053300

§ 371 Date: Jun. 20, 2025

(30) Foreign Application Priority Data
Dec. 23, 2022 (GB) 2219729.7

(51) Int. Cl. E04B 2/74

(52) U.S. Cl. CPC E04B 2/7437

(57) ABSTRACT

A wall panel system. The wall panel system comprises a panel and a panel support handle. The panel comprises a first locking member biased towards a locked configuration and moveable to an unlocked configuration. The wall panel also comprises a first panel support handle guide The panel support handle defines an abutment. The panel support handle is configured to engage with the first panel support handle guide at a first position on the first panel support handle guide such that the abutment is spaced apart from the first locking member. The panel support handle is configured to be moveable along the first panel support handle guide to a second position on the first panel support handle guide such that the abutment engages with the first locking member to move it from the locked configuration to the unlocked configuration.

### BACKGROUND

Panel walls (e.g., walls fabricated from a series of panels which are connected together) are used in many ways, for example to create barriers around equipment, define pathways through a particular space and to divide a working space into different areas. Doors may be provided in the panel wall to allow passage therethrough, which may be lockable to control access.

It is common for such guard systems to be assembled using a multitude of fixings such as nuts, bolts, screws, clips etc. Such designs, although adaptable, are time consuming to put together, require the production and supply of a large part count, as well as the need to follow instructions which, if not interpreted correctly, may result in the assembly being put together incorrectly.

In an example in which the wall surrounds equipment or a storage area, it may be that a panel becomes damaged, for example if a vehicle should reverse into the panel, or debris from the equipment strikes the panel. This may then be removed and replaced. However, removal of the panel may be problematic, for example because passing through the wall may pose a risk to the user (for example if the wall surrounds dangerous equipment) or removal of the panel may cause a security risk (for example if the wall surrounds a goods storage area).

Hence a wall panel system which is easy to assemble, enables the use of less fixings than examples of the related art, and enables control of removal of the panels of the wall system, is highly desirable.

### SUMMARY

According to the present disclosure there is provided a system as set forth in the appended claims. Other features of the invention will be apparent from the dependent claims, and the description which follows.

Accordingly there may be provided a wall panel system (10). The wall panel system (10) may comprise a panel (100) and a panel support handle (400). The panel (100) may comprise a first locking member (102) biased towards a locked configuration and moveable to an unlocked configuration. The panel (100) may comprise a first panel support handle guide (104). The panel support handle (400) may define an abutment (402). The panel support handle (400) may be configured to engage with the first panel support handle guide (104) at a first position on the first panel support handle guide (104) such that the abutment (402) is spaced apart from the first locking member (102). The panel support handle (400) may be configured to be moveable along the first panel support handle guide (104) to a second position on the first panel support handle guide (104) such that the abutment (402) engages with the first locking member (102) to move it from the locked configuration to the unlocked configuration.

The panel support handle (400) may be configured to be moveable along the first panel support handle guide (104) from the second position on the first panel support handle guide (104) to the first position on the first panel support handle guide (104) such that the abutment (402) disengages from the first locking member (102) so that the first locking member (102) moves from the unlocked configuration to the locked configuration.

The first panel support handle guide (104) may define a first stop (106) positioned such that the panel support handle (400) engages with the first stop (106) after the panel support handle (400) has moved sufficiently far along the first panel support handle guide (104) for the abutment (402) to engage with the first locking member (102) to move the first locking member (102) from the locked configuration to the unlocked configuration, the first stop (106) being configured to prevent the panel support handle (400) moving further along the first panel support handle guide (104) such that the panel (100) can be carried by the panel support handle (400).

The first locking member (102) may comprises a catch member (108).

The first panel support handle guide (104) may comprise a first recess (112) on a first side (114) of the panel (100) for receiving the panel support handle (400). The first panel support handle guide (104) may further comprise guide members (130) which are provided in the first recess (112) to engage with compatible guide members (430) on the panel support handle (400). The guide members (130) of the first panel support handle guide (104) may be configured to constrain the panel support handle (400) to move along a path defined between the first position and the second position.

The guide members (130) of the first panel support handle guide (104) and the guide members (430) of the panel support handle (400) may be provided as tabs (110) configured to overlap and engage.

The panel (100) may further comprise a second panel support handle guide (204) which comprises a second recess (212) on a second side (214) of the panel (100) for receiving the panel support handle (400). The second panel support handle guide (204) may comprise guide members (230) which are provided in the second recess (212) to engage with the guide members (430) on the panel support handle (400). The guide members (230) of the second panel support handle guide (204) may be configured to constrain the panel support handle (400) to move along a path defined by the second recess guide members (230). When the panel support handle (400) is in the second recess (212), the abutment (402) is spaced apart from the first locking member (102) on the panel (100).

The panel support handle (400) may be removeable from the panel (100) at the first position, and fixed to the panel (100) at the second position.

The wall panel system (10) may further comprise a panel support post (300). The panel (100) may define a post engagement feature (170). The panel support post (300) may define a panel engagement feature (312). The post engagement feature (170) and panel engagement feature (312) may be configured to engage so that the panel (100) is carried by the panel support post (300).

The post engagement feature (170) on the panel (100) may be provided as an elongate member (172) which extends from the panel support post (300). The panel engagement feature (312) on the panel support post (300) may be provided as a cavity (304) configured to receive the elongate member (172).

The panel support post (300) may comprise a second locking member (302) for engagement with the first locking member (102) such that in the locked configuration of the first locking member (102), the first locking member (102) is operable to be engaged with the second locking member (302) to prevent the post engagement feature (170) and panel engagement feature (312) from becoming disengaged; and in the unlocked configuration of the first locking member (102), the first locking member (102) is operable to be disengaged with the second locking member (302) to enable the post engagement feature (170) and panel engagement feature (312) to be separated.

The second locking member (302) may extend from the panel support post (300).

The wall panel system (10) may comprise at least one pair of panel support posts (300) spaced apart from one another with a panel (400) extending therebetween.

Hence there is provided a wall panel system 10 which is easy to assemble since panels 100 of the panel system 10 have an in-built locking arrangement (e.g., a first locking member 102) which can be engaged and disengaged with a panel support handle 400. Hence the fitting of the panel to the panel support post 300 is straightforward and allows for fewer fixings to be used than examples of the related art. Removal of the panel support handle 400 from the panel 100 prevents the first locking member 102 from being moved to an unlocked configuration, which prevents the panel 100 from being removed by an unauthorized user.

### BRIEF DESCRIPTION OF THE DRAWINGS

Examples of the present disclosure will now be described with reference to the accompanying drawings, in which:

FIG. 1 shows a plan view of an assembly of a wall panel system according to the present disclosure;

FIG. 2 is an exploded perspective view of a first side of an assembly of a panel, panel support handles and panel support posts of the present disclosure;

FIG. 3 is an exploded perspective view of a second side of an assembly of the panel, panel support handles and panel support posts of the present disclosure;

FIGS. 4, 5 show the first side of an assembly of the panel and panel support post of the present disclosure at different stages of assembly/disassembly;

FIGS. 6 to 7 show the second side of an assembly of the panel, panel support handle and panel support post of the present disclosure at different stages of assembly/disassembly;

FIGS. 8 to 10 show an enlarged view of the first side of an assembly of the panel and panel support post at different stages of assembly/disassembly;

FIG. 11 shows an enlarged view of the second side of an assembly of the panel, panel support handle and panel support post in a locked configuration;

FIGS. 12, 13 show an enlarged view of the second side of an assembly of the panel, panel support handle and panel support post in an unlocked configuration;

FIGS. 14 to 16 show views of the panel support handle according to the present disclosure;

FIG. 17 shows an enlarged view of the panel support handle guide on the second side of the panel;

FIG. 18 shows an enlarged view of the panel support handle guide on the first side of the panel;

FIG. 19 shows an enlarged view of the first side of the assembly of the panel and panel support handle in a locked configuration;

FIG. 20 shows an enlarged view of the first side of the assembly of the panel and panel support handle in an unlocked configuration;

FIG. 21 shows an enlarged perspective view of the first side of the panel and panel support handle pre-assembly with the panel in the locked configuration;

FIG. 22 shows an enlarged perspective view of the first side of the panel and panel support handle in the locked configuration;

FIG. 23 shows an enlarged perspective view of the first side of the panel and panel support handle in the unlocked configuration;

FIGS. 24 to 28 show steps in the installation of the wall panel system from the second side; and

FIGS. 29 to 33 show steps in removal of the wall panel system from the first side.

### DETAILED DESCRIPTION

The present disclosure relates to a wall panel system 10 for example for forming a partition wall assembly 12. The present disclosure also relates to a partition wall assembly 12 comprising the wall panel system 10.

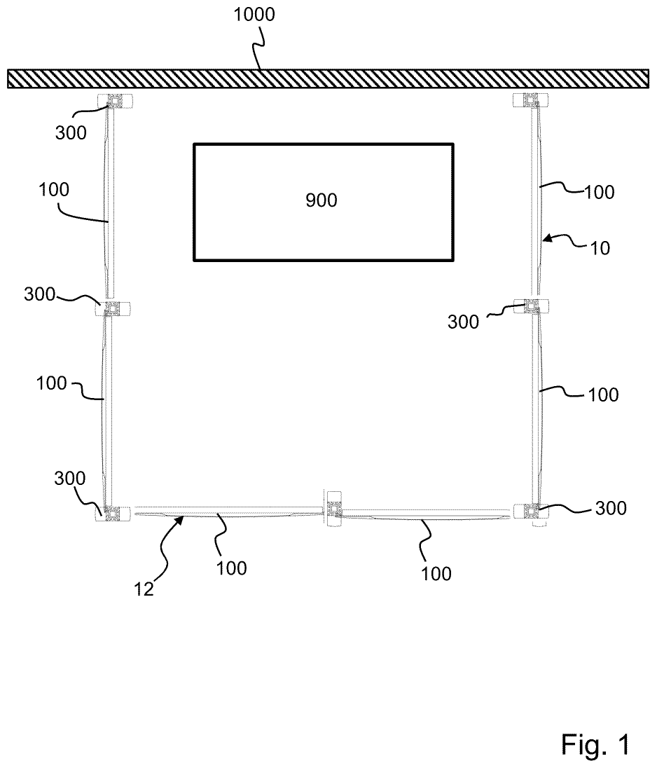

FIG. 1 shows a plan view of an example partition wall assembly 12 including a wall panel system 10 according to the present disclosure. The wall panel system 10 comprises a panel 100 and a panel support post 300. In the example shown, the wall panel system 10 comprises a plurality of panels 100 and a plurality of panel support posts 300. The panel support posts 300 are spaced apart from one another, with a panel 100 spanning the gap between each pair of adjacent posts 300. That is to say the wall panel system 10 may comprise at least one pair of panel support posts 300 spaced apart from one another with a panel 100 extending therebetween.

The panel 100 may have one or more transparent sections. For example, the panel 100 may define a frame section which extends around a central region, where the central region defines a transparent window. The panel 100 may have one or more translucent sections. For example, the panel 100 may define a frame section which extends around a central region, where the central region defines a translucent window. The panel 100 may be opaque. The panel 100 (e.g., frame section and central region) many be integrally formed. For example, the panel 100 (e.g., frame section and central region) many be integrally formed from a material comprising a polymer by an injection moulding process.

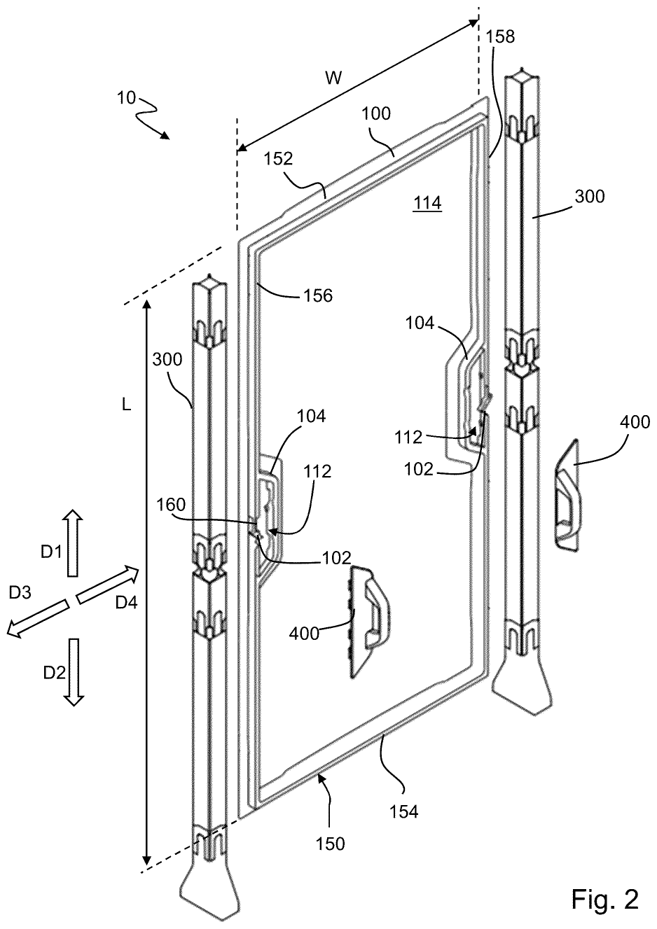

As labelled in FIG. 2, the wall panel 100 defines an outer edge wall section 150, the outer edge wall section 150 extending completely around (i.e. bounding) the perimeter of the panel 100. The outer edge wall section 150 comprises a first end edge section 152, a second end edge section 154, a first side edge section 156 and a second side edge section 158. The first end edge section 152 and second end edge section 154 are spaced apart from one another along the length (L) of the panel 100. The first side edge section 156 and the second side edge section 158 are apart from one another across the width (W) of the wall panel 100. The first side edge section 156 and the second side edge section 158 extend between the first end edge section 152 and second end edge section 154. The panel 100 has a first side 114 a second side 214 which define outer surfaces of the panel 100. The outer edge wall section 150 extends between the first side 114 the second side 214. Hence the first side 114 is opposite the second side 214.

In the example shown in FIG. 1, the wall assembly 12 extends from a fixed wall 1000 (for example a fixed/structural part of a building) around an apparatus 900. For example, the wall assembly 12 may be provided to limit access to the apparatus 900, or to provide protection from the apparatus 900 within the region defined by the wall assembly 12. That is to say the wall assembly 12 comprises a plurality of panels 100 and panel support posts 300 which are arranged to produce (i.e., define) the partition wall assembly 12 which may be configured to provide controlled access to an area, for example an area which houses an apparatus 900. For example, the apparatus 900 may be a welding unit or machining equipment, and the wall assembly 12 acts as a barrier between the apparatus and anyone and anything passing the wall assembly 12. However, the wall assembly 12 may be provided to define any shape or configuration-for example to define a walkway through an area, or to extend all of the way around a region (for example to define a work area in a warehouse).

FIGS. 2, 3, FIGS. 24 to 28 and FIGS. 29 to 33 illustrate part of the wall assembly 12, namely a wall panel 100 spanning the space between two panel support posts 300. The wall assembly 12 may comprise at least one panel support post 300 and one wall panel 100. The wall assembly 12 may comprise a plurality of panel support posts 300 and a plurality of wall panels 100. Features of the wall panel system 10 may be duplicated/repeated for each panel 100 and post 300 assembly.

In the figures the wall panel 100 is shown as being rectangular, but in practice may have any suitable shape and/or configuration.

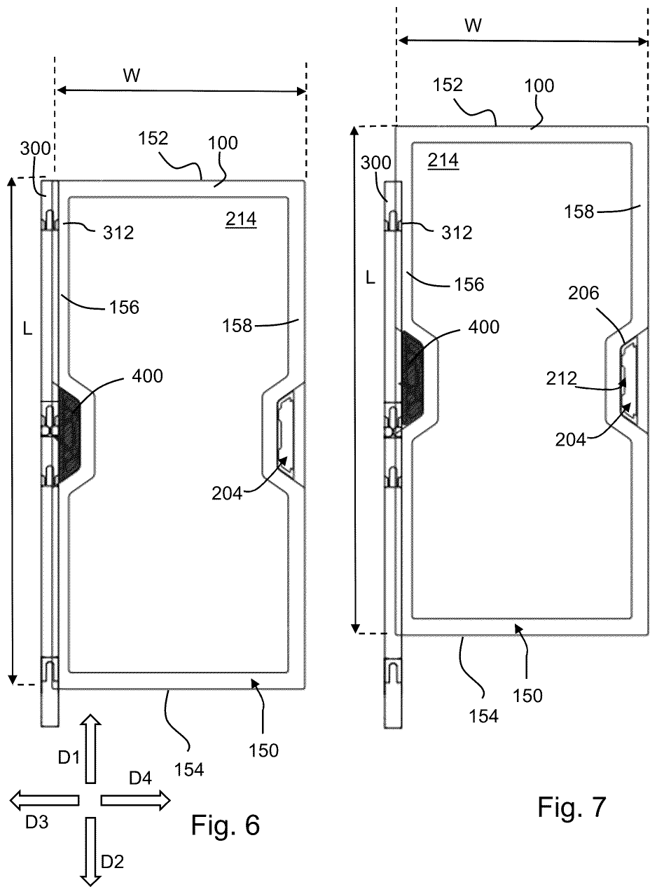

As illustrated in FIGS. 5, 6, 10, 11, 19, 27 to 30 the panel 100 is configured to be located at a mount position on the panel support post 300. That is to say the panel 100 is configured to be mounted/fixed to (i.e., located on) the panel support post 300. In the example shown in FIGS. 27 to 30 the wall panel 100 is mounted (e.g., fixed) to two panel support posts 300. In other examples (as shown in FIGS. 5, 6), the wall panel 100 may be mounted to only one support post 300.

The posts 300 to either side of the panel 100 may be substantially identical, and both posts 300 may support the panel 100. However only one post 300 may be utilised with regard to locking the panel 100 in place in the mount position. In other examples (as shown in the figures) posts 300 on both sides of the panel 100 may be utilized for locking the panel 100 in the mount position.

Hence locking features of the panel 100 may be provided on one side edge section the panel 100 (e.g., the first side edge section 156 or the second side edge section 158). Alternatively, as shown in the figures, locking features of the panel 100 may be provided on two side edge sections of the panel 100 (e.g., the first side edge section 156 and the second side edge section 158).

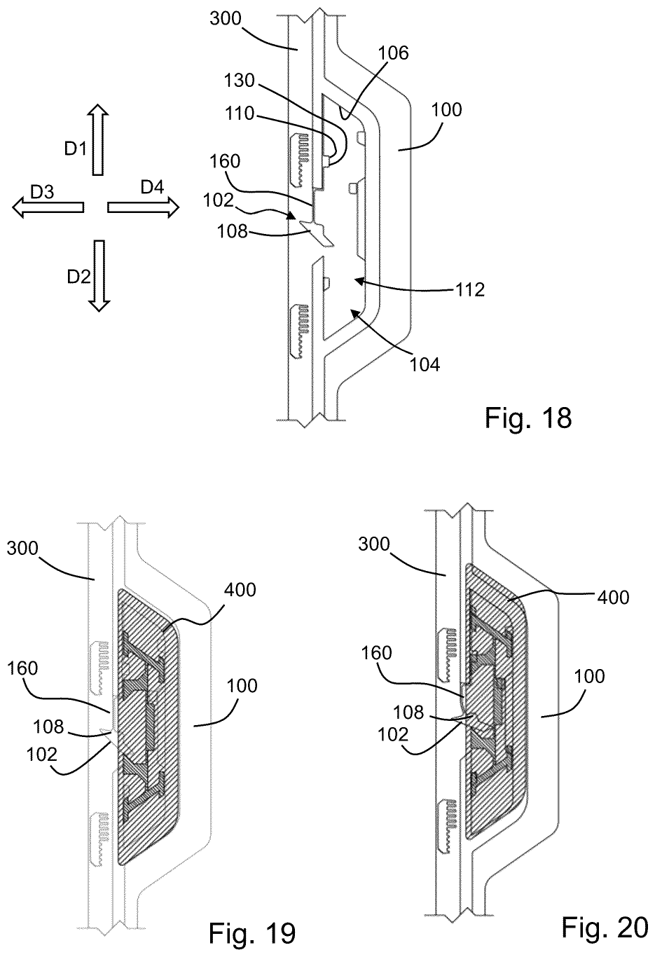

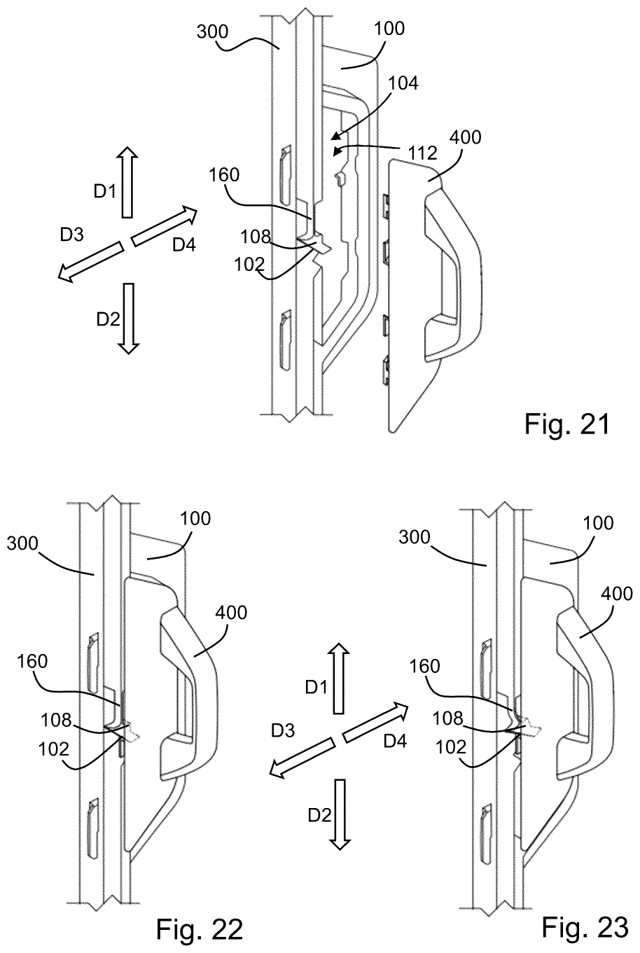

As illustrated in FIGS. 2, 4 to 13, 18 to 23, the panel 100 may comprise a first locking member 102 biased towards a locked configuration and moveable to an unlocked configuration. As best shown in FIGS. 18 to 23 the first locking member 102 may comprise a catch member 108. The first locking member 102 may comprise a resilient arm 160 which extends from the panel 100 to the catch member 108. The resilient arm 160 may be biased towards the locked configuration. That is to say, the resilient arm 160 may be biased to urge the catch member 108 outwards in a third direction D3 (i.e., in the width direction W, for example perpendicular to the length direction L in the plane of the panel 100) away from the centre of the panel 100 and towards the side edge section 156, 158 of the panel 100. Hence the first locking member 102 may be spring loaded towards the locked configuration. The first locking member 102 may be integrally formed with the panel 100. The first locking member 102 may be fixed to the panel 100.

As shown in FIGS. 2, 4, 5, 8 to 13, 18 to 23 the panel 100 may also comprise a first panel support handle guide 104.

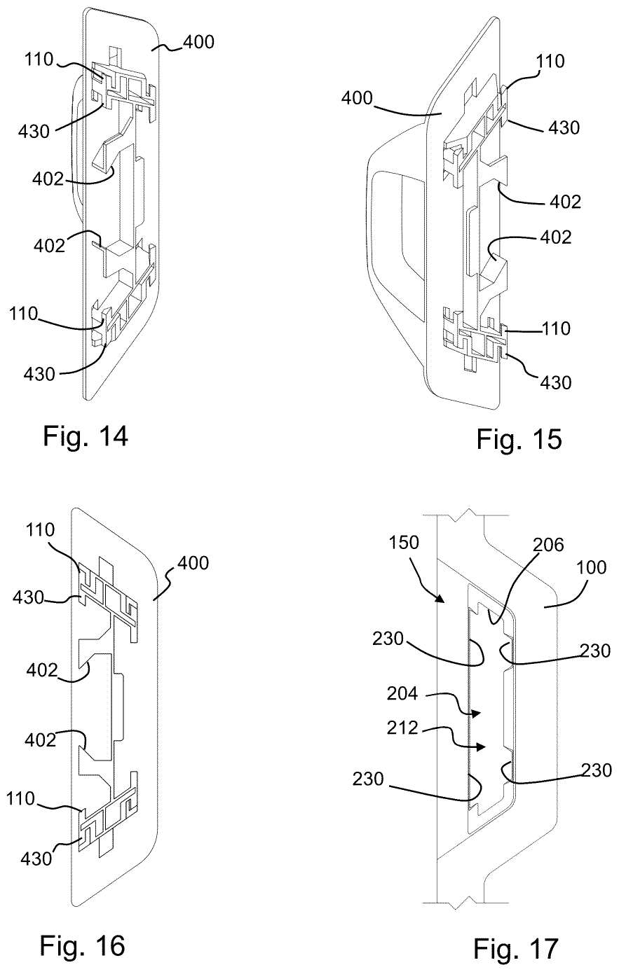

As illustrated in FIGS. 2, 3, 6, 7, 11 to 13, 19 to 33, and in particular in FIGS. 14 to 17, the wall panel system 10 may comprise a panel support handle 400. As best shown in FIGS. 14 to 17, the panel support handle 400 may define an abutment 402. The abutment 402 is configured for engagement with the first locking member 102 so as to move the first locking member 102 from a locked configuration to an unlocked configuration.

As shown in FIGS. 6, 11, 19, 22, 27, the panel support handle 400 may be configured to engage with the first panel support handle guide 104 at a first position on the first panel support handle guide 104 such that the abutment 402 is spaced apart from the first locking member 102.

As shown in FIGS. 2, 4, 5, 8 to 10, 11 to 13, 18 to 23, 29 to 33 the first panel support handle guide 104 may comprise a first recess 112 on the first side 114 of the panel 100 for receiving the panel support handle 400. That is to say on the first side 114 of the panel 100, the panel 100 may define the first recess 112 in which the first panel support handle guide 104 is located/formed. The first recess 112 may extend from the first side edge section 156. The first recess 112 may extend from the second side edge section 158. As shown in the figures, a first recess 112 may extend from each of the first side edge section 156 and second side edge section 158. The first recess 112 may be located about half of the way between the first end edge section 152 and second end edge section 154 along the length L of the panel 100.

The first panel support handle guide 104 may further comprise guide members 130 which are provided in the first recess 112 (as shown in FIG. 18) to engage with compatible guide members 430 on the panel support handle 400 (as shown in FIGS. 14, 15, 16). The guide members 130 of the first panel support handle guide 104 may be configured to constrain the panel support handle 400 to move along a path defined between the first position and the second position. That is to say, the guide members 130 of the first panel support handle guide 104 may be configured to constrain the panel support handle 400 to move along a path in the length direction L of the panel 100 defined between the first position and the second position. Put another way, the guide members 130 of the first panel support handle guide 104 may be configured to constrain the panel support handle 400 to move along a path in a first direction D1 (i.e., upwards, as shown in the figures) and to move along the same path a second direction D2 (i.e., downwards, as shown in the figures). Hence the second direction D2 is opposite to the first direction D1.

The guide members 130 of the first panel support handle guide 104 and the guide members 430 of the support handle 400 may be provided as tabs 110 configured to overlap and engage. That is, the guide members 130 of the first panel support handle guide 104 and the guide members 430 of the support handle 400 maybe provided as walls configured, sized and located so they overlap and engage when the support handle 400 is located in and moved along the first recess 112 in the length direction L of the panel (i.e., in the first direction D1).

As best illustrated by the motion of the panel support handle 400 between FIGS. 6 to 7, FIGS. 11 to 12, FIGS. 19 to 20, FIGS. 22 to 23, the panel support handle 400 may be configured to be moveable and/or slideable along the first panel support handle guide 104 in the first direction D1 from the first position on the first panel support handle guide 104 to the second position on the first panel support handle guide 104 such that the abutment 402 engages with the first locking member 102 so that the first locking member 102 moves from a locked configuration (as shown in FIGS. 19, 22) to an unlocked configuration (as shown in FIGS. 20, 23).

As best illustrated by the motion of the panel support handle 400 illustrated between FIGS. 7 to 6, FIGS. 12 to 11, FIGS. 20 to 19, FIGS. 23 to 22 the panel support handle 400 may be configured to be moveable and/or slideable along the first panel support handle guide 104 in the second direction D2 from the second position on the first panel support handle guide 104 to the first position on the first panel support handle guide 104 such that the abutment 402 disengages from the first locking member 102 so that the first locking member 102 moves from an unlocked configuration (as shown in FIGS. 20, 23) to a locked configuration (as shown in FIGS. 19, 22).

That is to say, the panel support handle 400 may be configured to be moveable and/or slideable along the first panel support handle guide 104 from the second position on the first panel support handle guide 104 to the first position on the first panel support handle guide 104 such that the abutment 402 disengages from the first locking member 102 so that the catch member 108 of the first locking member 102 moves in the third direction D3 from an unlocked configuration in which it is withdrawn from the side edge section 156, 158 of the panel 100 (as shown in FIGS. 20, 23) to a locked configuration in which it is moved towards the side edge section 156, 158 (as shown in FIGS. 19, 22).

Hence in the unlocked configuration the resilient arm 160 may be bent back on itself to withdraw the catch member 108 (as shown in FIGS. 20, 23) and in the locked configuration the resilient arm 160 is able to spring back to extend the catch member 108 for engagement with a second locking member 302 on the post 300.

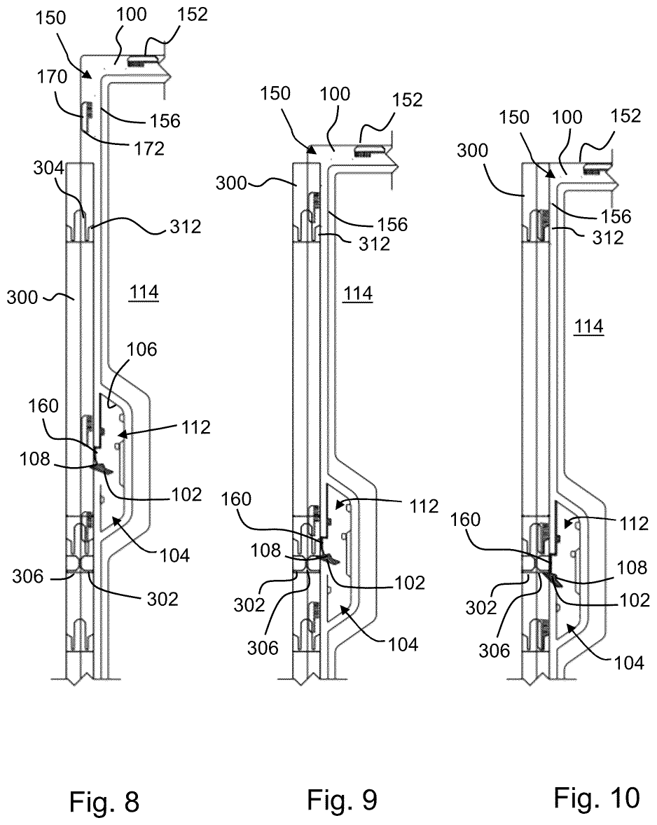

As shown in FIGS. 8 to 9, 18, 21, the first panel support handle guide 104 may define a first stop 106. The first stop 106 is positioned such that the panel support handle 400 engages with the first stop 106 after the panel support handle 400 has moved sufficiently far along the first panel support handle guide 104 in the first direction D1 for the abutment 402 to engage with the first locking member 102 to move the first locking member 102 from a locked configuration to an unlocked configuration. The first stop 106 may be positioned such that the panel support handle 400 engages with the first stop 106 after the panel support handle 400 has moved sufficiently far along the first panel support handle guide 104 in the length direction L (i.e. in the first direction D1) for the guide members 430 of the panel support handle 400 to engage with, slide along and be retained (i.e. caught) by the guide members 130 of the first panel support handle guide 104 so the panel support handle 400 is fixed to the panel 100. The first stop 106 may be configured to prevent the panel support handle 400 moving further along the first panel support handle guide 104 in the length direction L (i.e., in the first direction D1), and so that the panel support handle 400 reacts against the first stop 106 when the panel 100 is carried by the panel support handle 400. The first stop 106 may be part of a wall which defines the first recess 112.

The panel support handle 400 is removeable from the panel 100 when the panel support handle 400 is at the first position. The panel support handle 400 is fixed to the panel 100 when the panel support handle 400 is at the second position by virtue of the interconnection of the guide members 430 of the panel support handle 400 and the guide members 130 of the first panel support handle guide 104.

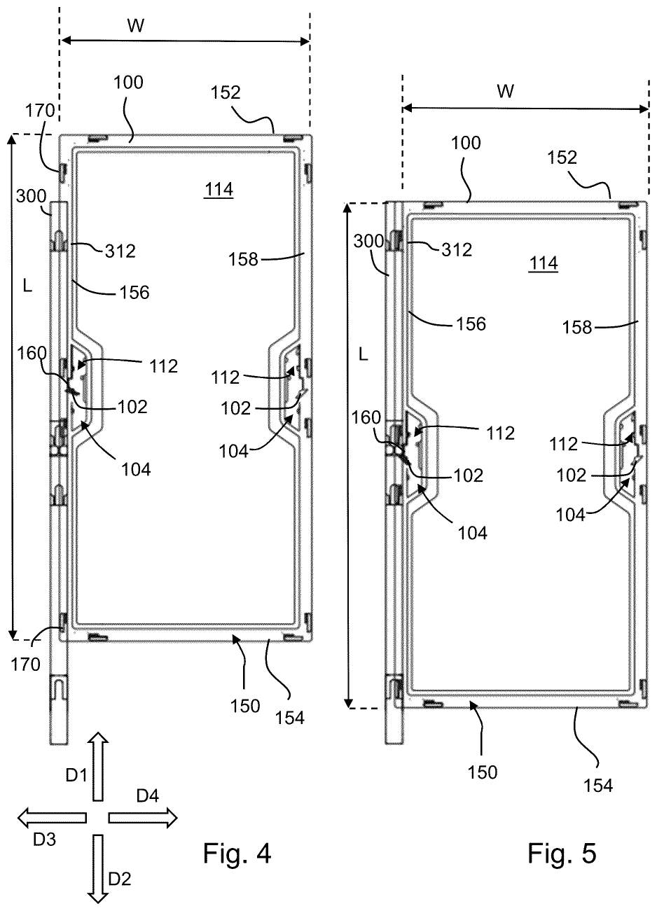

As illustrated in FIGS. 4 to 13, the panel 100 defines a post engagement feature 170. The post engagement feature 170 may be integrally formed with the panel 100. The post engagement feature 170 may be fixed to the panel 100. As shown in FIGS. 4, 5, post engagement features 170 may be provided on the side edge sections 156, 158. The post engagement features 170 may be provided on the side edge sections 156, 158 in the region where the side edge sections 156, 158 meet the first end edge section 152 and second end edge section 154 (e.g., at the top and bottom corners of the panel 100).

As illustrated in FIGS. 4 to 13, the panel support post 300 defines a panel engagement feature 312. The panel engagement feature 312 may be integrally formed with the post 300. The panel engagement feature 312 may be fixed to the post 300. As shown in FIGS. 4, 5 there may be provided a plurality of a panel engagement features 312 along the length of the post 300. The panel engagement features 312 may be spaced apart by the same distance in the length direction L as the post engagement features 170 on the panel 100. The or each post engagement feature 170 may be configured to engage with a corresponding panel engagement feature 312 so that the panel 100 is carried (e.g. supported) by the panel support post 300 so as to locate the panel 100 and panel support post 300 relative to one another in the mount position.

The or each post engagement feature 170 on the panel 100 may be provided as an elongate member 172 (e.g., finger or hook) which extends from the panel support post 300. The or each panel engagement feature 312 on the panel support post 300 may be provided as a cavity, aperture or chamber 304 configured to receive the elongate member 172.

As best shown in FIGS. 8 to 9, the panel support post 300 may comprise the second locking member 302 for engagement with the first locking member 102. The second locking member 302 extends from the panel support post 300. The second locking member 302 may be provided as an engagement land 306 which extends from the panel support post 300.

In the locked configuration of the first locking member 102, the first locking member 102 is operable to be engaged with the second locking member 302 to prevent the first locking member 102 moving past the second locking member 302 in the first direction D1, and to thereby prevent the or each post engagement feature 170 and the corresponding panel engagement feature 312 from becoming disengaged.

In the unlocked configuration of the first locking member 102, the first locking member 102 may be operable to be disengaged from the second locking member 302 to enable the first locking member 102 to move past the second locking member 302 in the first direction D1, and to thereby enable the post engagement features 170 and panel engagement features 312 to be separated and thereby allow the panel 100 to be removed from the panel support post 300. In some examples, in the unlocked configuration the catch member 108 may be moved to a position where it is clear of (e.g., spaced apart from) the second locking member 302 so the catch member 108 may move past the locking member 302. In other examples, for example as shown in FIG. 9, in the unlocked configuration the catch member 108 may be angled/tilted relative to the second locking member 302 so that when the catch member 108 travels in the first direction D1, a face of the catch member 108 which faces the second locking member 302 is angled relative to the second locking member 302 so that the catch member 108 is pushed inwardly in the fourth direction D4 (i.e. in the width direction W, opposite to the third direction D3), causing the resilient arm 160 to bend back on itself to allow the catch member 108 to move past the second locking member 302.

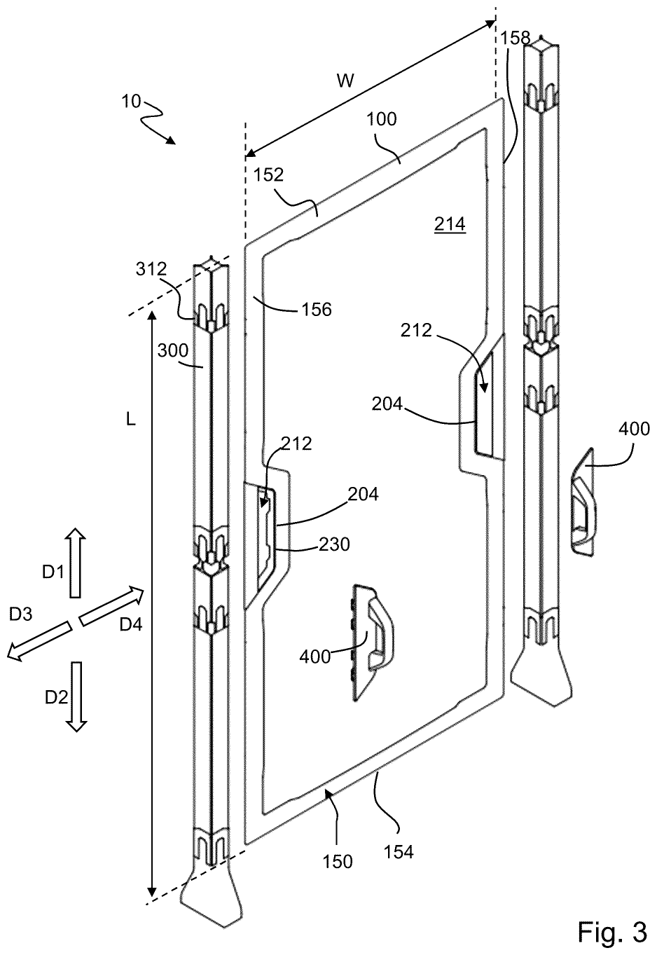

As shown in FIGS. 3, 6, 7, 17, 24 to 28 the panel 100 further comprises a second panel support handle guide 204 on a second side 214 of the panel 100 (i.e., on the opposite side of the panel 100 to the first recess 112). The second panel support handle guide 204 comprises a second recess 212 for receiving the panel support handle 400. That is to say on the second side 214 of the panel 100, the panel 100 may define the second recess 212 in which the second panel support handle guide 204 is located/formed. The second recess 212 may extend from the first side edge section 156. The second recess 212 may extend from the second side edge section 158. As shown in the figures, a second recess 212 may extend from each of the first side edge section 156 and second side edge section 158. The second recess 212 may be located about half of the way between the first end edge section 152 and second end edge section 154 along the length direction L of the panel 100.

As best shown in FIG. 17, the second panel support handle guide 204 may comprise guide members 230 which are provided in the second recess 212 to engage with the guide members 430 on the panel support handle 400. The guide members 230 of the second panel support handle guide 204 may be configured to constrain the panel support handle 400 to move along a path defined by the second recess guide members 230 (e.g., in the length direction L of the panel 100). The guide members 230 of the second panel support handle guide 204 may be configured to constrain the panel support handle 400 to move along a path defined between the first position and the second position. That is to say, the guide members 230 of the second panel support handle guide 204 may be configured to constrain the panel support handle 400 to move along a path in the length direction L of the panel defined between the first position and the second position. Put another way, the guide members 230 of the second panel support handle guide 204 may be configured to constrain the panel support handle 400 to move along a path in the first direction D1 (i.e., upwards, as shown in the figures) and to move along the same path the second direction D2 (i.e., downwards, as shown in the figures).

The second panel support handle guide 204 may define a second stop 206, as shown in FIG. 17. The second stop 206 may be positioned such that the panel support handle 400 engages with the second stop 206 after the panel support handle 400 has moved sufficiently far along the panel support handle guide 204 in the length direction L (i.e. in the first direction D1) for the guide members 430 of the panel support handle 400 to engage with, slide along and be retained (i.e. caught) by the guide members 230 of the panel support handle guide 204 so that the panel support handle 400 is fixed to the panel 100. The second stop 206 may be configured to prevent the panel support handle 400 moving further along the panel support handle guide 204 in the length direction L (i.e., in the first direction D1), and so that the panel support handle 400 reacts against the second stop 206 when the panel 100 is carried by the panel support handle 400. The second stop 206 may be part of a wall which defines the second recess 212.

When the panel support handle 400 is in the second recess 212, the abutment 402 is spaced apart from the first locking member 102 on the panel 100. Hence in the example shown, the first locking member 102 can be operated from only the first side 114 of the panel 100. That is to say, the abutment 402 of the panel support handle 400 will engage with the first locking member 102 of the panel 100 to disengage the first locking member 102 from the second locking member 302 on the post 300 from the first side 114 of the panel 100, but not from the second side 214. On the second side 214, the panel support handle 400 will fit in and engage with the second recess 212 so that the panel 100 may be lifted by the panel support handle 400, but the abutment 402 of the panel support handle 400 will be positioned so it is spaced apart from the first locking member 102, and hence will not engage nor move the first locking member 102.

In another example, not shown, the second recess 212, first locking member 102, and panel support handle 400 are configured so that when the panel support handle 400 is entered in the second recess 212, the abutment 402 of the panel support handle 400 will engage with the first locking member 102 of the panel 100 to disengage the first locking member 102 from the second locking member 302 on the post 300. Hence, in this example, the panel support handle 400 will unlock the panel 100 from the post 300 from both the first side 114 and second side 214.

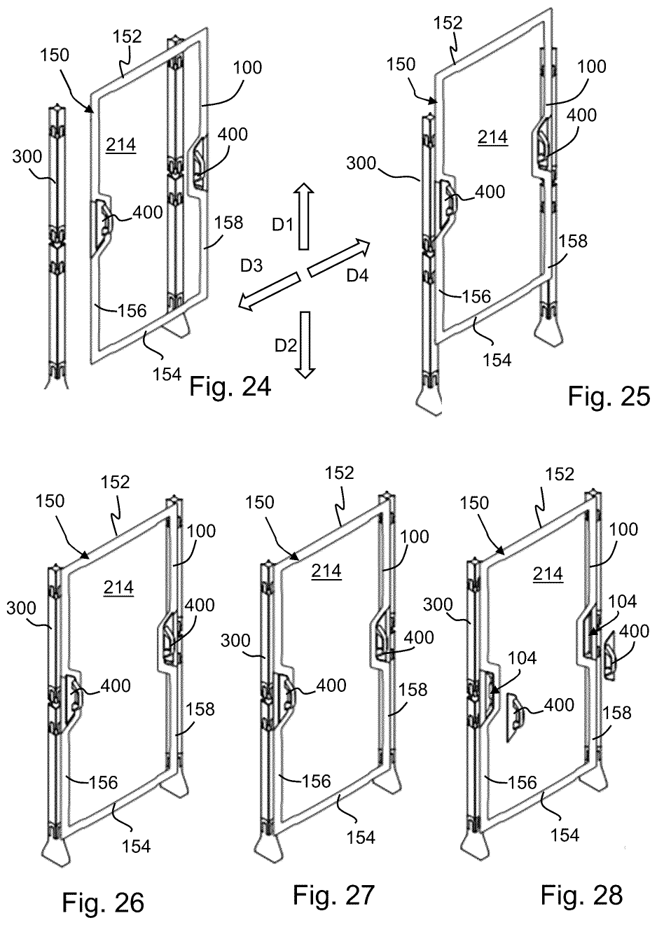

The method for fitting the panel 100 to a post 300 will now be described with reference to FIGS. 24 to 28, in which the panel 100 is operated with two panel support handles 400. For clarity, the operation of only one panel support handle 400 is described. However, regardless of whether one or more panel support handles 400 are used, the operation is the same for each.

As shown in FIG. 24 the panel support handle 400 is first located in the second recess 212 so that the guide members 230 of the second panel support handle guide 204 engage with the guide members 430 on the panel support handle 400. The panel support handle 400 is first located in the second recess 212 so the guide members 230 of the second panel support handle guide 204 engage with the guide members 430 on the panel support handle 400 such that the panel support handle 400 is constrained to move along a path defined by the second recess guide members 230 in the first direction D1 (e.g. in the length direction L of the panel 100) till the panel support handle 400 abuts the second stop 206 in the second recess 212.

The panel 100 is then lifted to a position as shown in FIGS. 4, 8, 25 to align the post engagement features 170 on the panel 100 with the respective panel engagement features 312 on the panel support post 300. In examples in which the panel 100 is supported by two posts 300, then the post engagement features 170 on both side edge sections 156, 158 are aligned with the respective panel engagement features 312 on the panel support posts 300.

The panel 100 is then lowered in the second direction D2 (as shown in FIGS. 5, 9) so that the post engagement features 170 on the panel 100 engage with the panel engagement features 312 on the panel support post 300.

The panel is then lowered more in the second direction D2 (as shown in FIGS. 10, 26) until the first locking member 102 on the panel 100 moves past the second locking member 302 on the post 300 and moves outwardly in the third direction D3 (i.e., in the width direction W) so that the first locking member 102 sits beneath the second locking member 302. That is to say, the panel 100 is lowered in the second direction D2 so that the first locking member 102 is in the unlocked configuration before it moves past the second locking member 302, and then in the locked configuration once it has moved past the second locking member 302. In examples in which the first locking member 102 is provided on both the first side edge section 156 and second side edge section 158, the process (i.e. mode of operation) is the same for both first locking members 102.

At this point the panel 100 is then lowered further in the second direction D2 so that the post engagement features 170 on the panel 100 rest on the panel engagement features 312 on the panel support post 300 so that the panel support post 300 takes the weight of the panel 100.

As shown in FIG. 27, the panel support handle 400 is then slid “downwards” in the second direction D2 such that the guide members 430 on the panel support handle 400 slide past and disengage from the guide members 230 of the second panel support handle guide 204. The or each panel support handle 400 may then be moved free of (i.e. removed from) the second recess 212 and panel 100, as shown in FIG. 28.

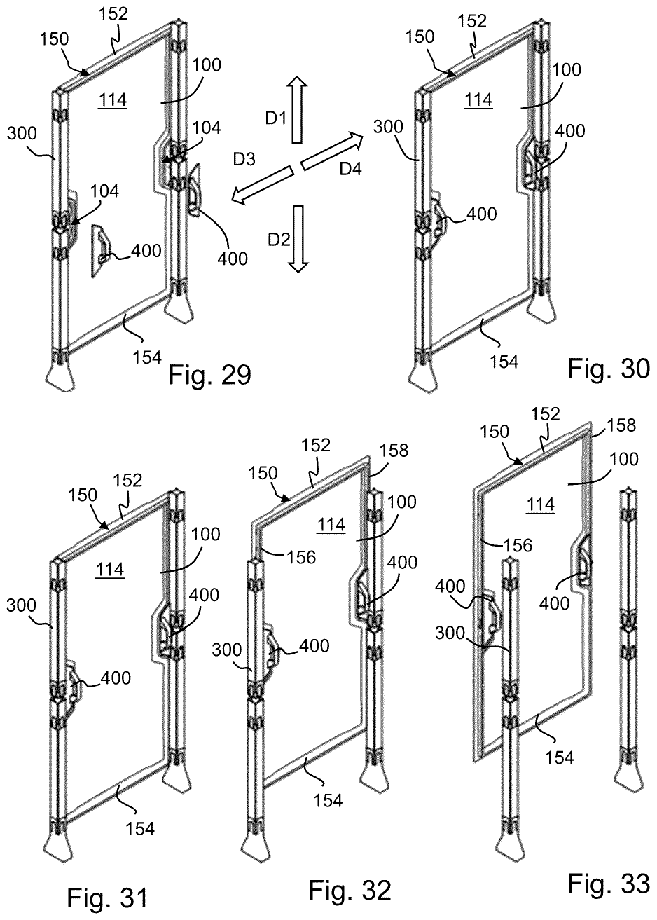

The method of removal of the panel 100 from the post 300 will now be described with reference to FIGS. 29 to 33, in which the panel 100 is operated with two panel support handles 400. For clarity, the operation of only one panel support handle 400 is described. However, regardless of whether one or more panel support handles 400 are used, the operation is the same for each.

As shown in FIG. 30 the panel support handle 400 is first located in the first recess 112 on the first side 114 of the panel 100 so that the guide members 130 of the first panel support handle guide 104 engage with the guide members 430 on the panel support handle 400. The panel support handle 400 is first located in the first recess 112 so the guide members 130 of the first panel support handle guide 104 engage with the guide members 430 on the panel support handle 400 such that the panel support handle 400 is constrained to move along a path defined by the first recess guide members 130 in the first direction D1 (e.g. in the length direction L of the panel 100) till the panel support handle 400 abuts the first stop 106 in the first recess 112.

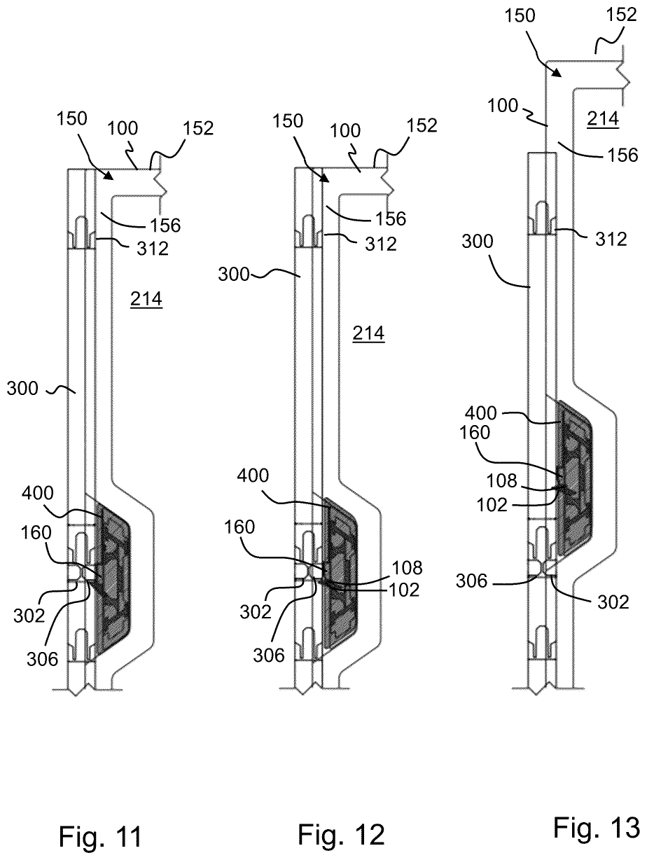

Referring now to FIGS. 11 to 13, at this point the first locking member 102 sits beneath (e.g., is engaged with) the second locking member 302, as shown in FIG. 11. Hence at this point the panel support handle abutment 402 is at the first position and is spaced apart from the first locking member 102. The panel support handle 400 is then moved along the constrained path defined by the first recess guide members 130 in the first direction D1 (e.g. in the length direction L of the panel 100) to the second position till the panel support handle 400 abuts the first stop 106 in the first recess 112, and the abutment 402 engages with the first locking member 102 to move it from the locked configuration (FIGS. 11, 19, 22) to the unlocked configuration (FIGS. 12, 20, 23).

The panel 100 can then be lifted in the first direction D1 to a position as shown in FIGS. 13, 32 so the first locking member 102 can move past the second locking member 302 in the first direction D1, and so the post engagement features 170 on the panel 100 are disengaged from the respective panel engagement features 312 on the panel support post 300. The panel 100 can then be lifted free of the posts 300 in the first direction D1, as shown in FIG. 33 and carried by the panel support handles 400.

The panel 100 can also be fitted to a post 300 with the panel support handles 400 in the first recess 112.

The panel support handle 400 is first located in the first recess 112 on the first side 114 of the panel 100 so that the guide members 130 of the first panel support handle guide 104 engage with the guide members 430 on the panel support handle 400. At this point the panel support handle abutment 402 is at the first position and is spaced apart from the first locking member 102. The panel support handle 400 is then moved along the constrained path defined by the first recess guide members 130 in the first direction D1 (e.g. in the length direction L of the panel 100) to the second position till the panel support handle 400 abuts the first stop 106 in the first recess 112, and the abutment 402 engages with the first locking member 102 to move it from the locked configuration (FIGS. 11, 19, 22) to the unlocked configuration (FIGS. 12, 20, 23).

The panel 100 is then lifted to a position as shown in FIGS. 4, 8 to align the post engagement features 170 on the panel 100 with the respective panel engagement features 312 on the panel support post 300. In examples in which the panel 100 is supported by two posts 300, then the post engagement features 170 on both side edge sections 156, 158 are aligned with the respective panel engagement features 312 on the panel support posts 300.

The panel 100 is then lowered in the second direction D2 (as shown in FIGS. 5, 9) so that the post engagement features 170 on the panel 100 engage with the panel engagement features 312 on the panel support post 300.

The panel 100 is then lowered more in the second direction D2 (as shown in FIG. 10) until the first locking member 102 on the panel 100 moves past the second locking member 302 on the post 300. At this point the panel 100 is then lowered further in the second direction D2 so that the post engagement features 170 on the panel 100 rest on the panel engagement features 312 on the panel support post 300 so that the panel support post 300 takes the weight of the panel 100.

The panel support handle 400 is then slid “downwards” in the second direction D2 such that the guide members 430 on the panel support handle 400 slide along the guide members 130 of the first panel support handle guide 104. That is, the panel support handle 400 moves along the first panel support handle guide 104 from the second position on the first panel support handle guide 104 to the first position on the first panel support handle guide 104 such that the abutment 402 disengages from the first locking member 102 so that the first locking member 102 moves from an unlocked configuration to a locked configuration. Hence the first locking member 102 moves outwardly in the third direction D3 (i.e., in the width direction W) so that the first locking member 102 sits beneath the second locking member 302.

Hence the act of lifting the panel 100 with the panel support handle 400 (e.g., to locate it on the panel support post 300) places the first locking member 100 into the unlocked configuration for attachment to the panel 100. Once the panel 100 has been located into position on the post 300, the act of removing the panel support handle 400 engages the first locking member 102 with the second locking member 302.

The panel support handle 400 is then slid “downwards” in the second direction D2 such that the guide members 430 on the panel support handle 400 slide past and disengage from the guide members 130 of the first panel support handle guide 104. The or each panel support handle 400 may then be moved free of (i.e. removed from) the first recess 112 and panel 100.

Hence there is provided a wall panel system 10 which is easy to assemble and fix together since the panel 100 of the panel system has an in-built locking arrangement (e.g. the first locking member 102) which is engaged when the panel 100 has been located in its mount position on the post 300 (for example when the panel support handle 400 is removed from the first side 114 of the panel 100, or when the panel support handle 400 is used to lift the panel 100 from the second side 214 of the panel 100, and/or even if the panel 100 is lifted and located on the post 300 without the panel support handle 400).

The panel 100 is also easily disengaged from the post 300 by use of the panel support handle 400 on the first side 114 of the panel 100 to disengage the first locking member 102 as part of the act of lifting the panel 100 from the posts 300.

However, the panel 100 cannot be disengaged from the post 300 without use of the panel support handle 400. Hence removal of the panel support handle 400 from the panel 100 prevents the first locking member 102 from being moved to an unlocked configuration, which prevents the panel 100 from being removed by an unauthorized user.

Since the features which hold the panel 100 to panel support post 300 together are formed integrally on each (i.e., as part) of the panel 100 and panel support post 300, the assembly of the posts 300 and panels 100 is straightforward and allows for fewer fixings to be used than in examples of the related art.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A wall panel system comprising:
a panel and a panel support handle;
wherein the panel comprises:
a first locking member biased towards a locked configuration and moveable to an unlocked configuration; and
a first panel support handle guide,
wherein the panel support handle defines an abutment,
wherein the panel support handle is configured to engage with the first panel support handle guide at a first position on the first panel support handle guide such that the abutment is spaced apart from the first locking member, and
wherein the panel support handle is configured to be moveable along the first panel support handle guide to a second position on the first panel support handle guide such that the abutment engages with the first locking member to move it from the locked configuration to the unlocked configuration.

2. A wall panel system as claimed in claim 1, wherein:
the panel support handle is configured to be moveable along the first panel support handle guide from the second position on the first panel support handle guide to the first position on the first panel support handle guide such that the abutment disengages from the first locking member so that the first locking member moves from the unlocked configuration to the locked configuration.

3. A wall panel system as claimed in claim 1, wherein the first panel support handle guide defines a first stop positioned such that the panel support handle engages with the first stop after the panel support handle has moved sufficiently far along the first panel support handle guide for the abutment to engage with the first locking member to move the first locking member from the locked configuration to the unlocked configuration, and
wherein the first stop being configured to prevent the panel support handle moving further along the first panel support handle guide such that the panel can be carried by the panel support handle.

4. A wall panel system as claimed in claim 1, wherein the first locking member comprises a catch member.

5. A wall panel system as claimed in claim 1, wherein the first panel support handle guide comprises a first recess on a first side of the panel for receiving the panel support handle, and
wherein the first panel support handle guide further comprises guide members which are provided in the first recess to engage with compatible guide members on the panel support handle the guide members of the first panel support handle guide being configured to constrain the panel support handle to move along a path defined between the first position and the second position.

6. A wall panel system as claimed in claim 5, wherein the guide members of the first panel support handle guide and the guide members of the panel support handle are provided as tabs configured to overlap and engage.

7. A wall panel system as claimed in claim 5, wherein the panel further comprises a second panel support handle guide which comprises a second recess on a second side of the panel for receiving the panel support handle, the second panel support handle guide comprising guide members which are provided in the second recess to engage with the guide members on the panel support handle, the guide members of the second panel support handle guide being configured to constrain the panel support handle to move along a path defined by the second recess guide members,
wherein when the panel support handle is in the second recess, the abutment is spaced apart from the first locking member on the panel.

8. A wall panel system as claimed in claim 1, wherein the panel support handle is removeable from the panel at the first position, and fixed to the panel at the second position.

9. A wall panel system as claimed in claim 1, further comprising a panel support post, wherein:
the panel defines a post engagement feature; and
the panel support post defines a panel engagement feature, the post engagement feature and panel engagement feature being configured to engage so that the panel is carried by the panel support post.

10. A wall panel system as claimed in claim 9, wherein the post engagement feature on the panel is provided as an elongate member which extends from the panel support post, and
wherein the panel engagement feature on the panel support post is provided as a cavity configured to receive the elongate member.

11. A wall panel system as claimed in claim 9, wherein the panel support post comprises a second locking member for engagement with the first locking member, such that in the locked configuration of the first locking member, the first locking member is operable to be engaged with the second locking member to prevent the post engagement feature and panel engagement feature from becoming disengaged, and
wherein in the unlocked configuration of the first locking member, the first locking member is operable to be disengaged with the second locking member to enable the post engagement feature and panel engagement feature to be separated.

12. A wall panel system as claimed in claim 11, wherein the second locking member extends from the panel support post.

13. A wall panel system as claimed in claim 9, further comprising at least one pair of panel support posts spaced apart from one another with a panel extending therebetween.
